(19) United States
(12) Patent Application Publication
(10) Pub. No.: US 2026/0275949 A1
(43) Pub. Date: Sep. 17, 2026

(54) ADDITIVE COMPOSITION FOR COMMON RAIL DIESEL ENGINE FUEL

(71) Applicant: Yuka Sangyo Co., Ltd., Tokyo (JP)

(72) Inventors: Yuki YAMAMOTO, Tokyo (JP); Junji MATSUDA, Tokyo (JP); Yoshihiro ANDO, Tokyo (JP)

(73) Assignee: Yuka Sangyo Co., Ltd., Tokyo (JP)

(21) Appl. No.: 19/473,663

(22) PCT Filed: Apr. 10, 2024
(86) PCT No.: PCT/JP2024/014465

§ 371 Date: Oct. 8, 2025

(30) Foreign Application Priority Data
Apr. 11, 2023 (JP) 2023-064216

(51) Int. Cl. F02M 65/00; C10L 1/222; C10L 1/224; C10L 1/232; F02M 55/02

(52) U.S. Cl. CPC F02M 65/007; C10L 1/222; C10L 1/224; C10L 1/232; F02M 55/025; C10L 2200/0446

(57) ABSTRACT

The present invention provides an additive composition for fuel for a common rail diesel engine, containing the following component (a) to component (c): (a) a compound represented by the formula (1), (b) a compound represented by the formula (2), and (c) a compound represented by the formula (3) and/or a compound represented by the formula (4), wherein a content of component (a) is 2 to 85% by mass, a content of component (b) is 10 to 85% by mass, a content of component (c) is 5 to 50% by mass, and a total content of component (a) to component (c) is 20 to 100% by mass, each based on the whole additive composition.

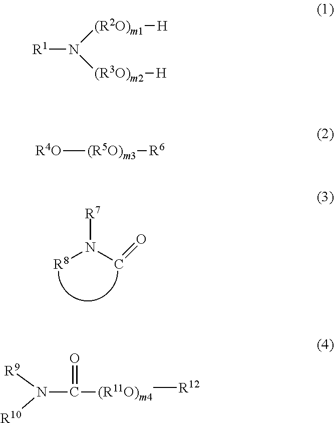

### TECHNICAL FIELD

The present invention relates to an additive composition to be added to fuel for a common rail diesel engine, and a method for cleaning a control valve in an injector of a common rail diesel engine by using the additive composition.

### BACKGROUND ART

In response to exhaust gas regulations, diesel engines using common rail systems is increasing in number. In a common rail system, fuel is pressurized by a fuel injection pump and stored in a common rail, which is a pressure chamber, and the start and end of fuel injection are controlled by controlling the nozzle back pressure with a solenoid valve of the injector. As a result, in a common rail diesel engine, the temperature of the diesel fuel rises under high pressure, and the temperature of the diesel fuel further rises while circulating within the common rail system.

As the temperature of diesel fuel rises, the diesel fuel deteriorates, causing contaminants to form and attach to the nozzle needle inside the injector. As a result, the injection amount of the fuel varies and engine trouble occurs.

As countermeasures against the attachment of contaminants, various fuel additives are known. For example, Patent Literature 1 describes a fuel additive containing an oxyalkylene compound of aliphatic amine and polyoxyalkylene glycol monoether. Patent Literature 2 describes a fuel oil additive composed of a heterocyclic compound such as pyrrolidine and the like. Patent Literature 3 describes a fuel composition containing a propoxylate additive. Patent Literature 4 describes a fuel oil containing ethyl cellosolve or the like. Patent Literature 5 describes a cleaning agent composition composed of a hydrocarbon-based base material, water, and alcohol. In addition, Patent Literature 6 describes a cleaning agent composition composed of a hydrocarbon-based base material, a surfactant, and water.

### CITATION LIST

### Patent Literature

### Patent Literature 1

JP 02-194089 A

### Patent Literature 2

WO 01/088066

### Patent Literature 3

JP 2002-520444 A

### Patent Literature 4

JP 2003-64384 A

### Patent Literature 5

JP 2008-81626 A

### Patent Literature 6

JP 2008-81627 A

### SUMMARY OF INVENTION

### Technical Problem

Exhaust gas regulations are becoming stricter every year. In order to improve combustion efficiency inside the engine, suppress soot generation, and comply with exhaust gas regulations, the injection pressure, which was conventionally about 150 MPa, has been increased to 200 MPa or more, aiming at making the sprayed fuel droplets finer and making the fuel concentration in the cylinder uniform. As the pressure rises, the temperature of diesel fuel rises further, making problems such as contamination, seizure, and fuel leaks due to component deterioration more likely to occur. Therefore, in order to reduce the amount of fuel that has been degraded by high temperature and returns to the fuel tank, the sliding gap in the control valve inside the injector tends to be set narrower than before in common rail diesel engines.

However, the narrower sliding gap of the control valve has given rise to a new problem that even a small amount of contaminants can cause variation in the injection amount. Furthermore, in a control valve with a narrower sliding gap, the amount of fuel passing through the gap is small, reducing the amount of contact between the additive in the fuel and the contaminants, and the effect of the additive to clean contaminants attached to the control valve decreases.

The present invention has been made in view of the above-mentioned problems, and aims to provide an additive composition for fuel for a common rail diesel engine, which can clean a gap in a control valve in an injector of the common rail diesel engine.

### Solution to Problem

[1] An additive composition for fuel for a common rail diesel engine, comprising the following component (a) to component (c):
(a) a compound represented by the formula (1):

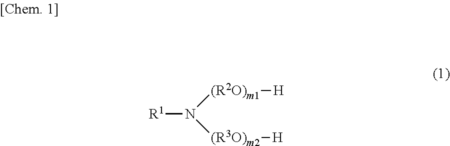

wherein R¹ is an alkenyl group having 12 to 22 carbon atoms,
   R² and R³ are each independently an alkylene group having 2 to 4 carbon atoms,
   m1 and m2 are each independently an integer of 1 to 10,
   when m1 is an integer of two or more, multiple R²s are the same as or different from each other, and

when m2 is an integer of two or more, multiple R³s are the same as or different from each other,
(b) a compound represented by the formula (2):

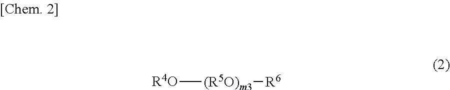

wherein R⁴ is an alkyl group having 1 to 8 carbon atoms,
   R⁵ is an alkylene group having 2 to 4 carbon atoms,
   R⁶ is a hydrogen atom or an alkyl group having 1 to 8 carbon atoms,
   m3 is an integer of 1 to 4, and
   when m3 is an integer of two or more, multiple R⁵s are the same as or different from each other, and
(c) a compound represented by the formula (3):

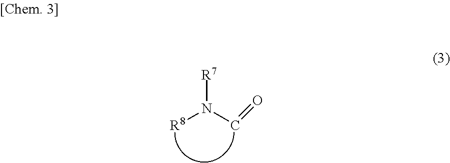

wherein R⁷ is an alkyl group having 1 to 8 carbon atoms, and
   R⁸ is an alkylene group having 2 to 5 carbon atoms, and/or a compound represented by the formula (4):

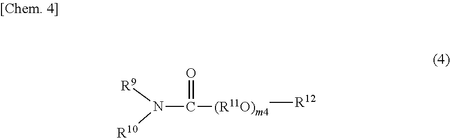

wherein R⁹ and R¹⁰ are each independently an alkyl group having 1 to 4 carbon atoms,
   R¹¹ is an alkylene group having 2 to 4 carbon atoms,
   R¹² is an alkyl group having 1 to 4 carbon atoms,
   m4 is an integer of 1 to 3, and
   when m4 is an integer of two or more, multiple R¹¹s are the same as or different from each other, wherein
   a content of component (a) is 2 to 85% by mass, a content of component (b) is 10 to 85% by mass, a content of component (c) is 5 to 50% by mass, and a total content of component (a) to component (c) is 20 to 100% by mass, each based on the whole additive composition.
      [2] The additive composition of the aforementioned [1], which is for a fuel for a common rail diesel engine with a fuel injection pressure of 200 MPa or more.
      [3] A method for cleaning a control valve inside an injector of a common rail diesel engine, comprising supplying a mixture of the additive composition of the aforementioned [1] or [2] and diesel fuel to the common rail diesel engine, wherein
a content of the aforementioned composition in the aforementioned mixture is 0.5 to 5 parts by mass relative to 100 parts by mass of the diesel fuel.

### Advantageous Effects of Invention

Using a mixture of the additive composition of the present invention and diesel fuel (that is, diesel fuel containing the additive composition of the present invention), contaminants attached to a control valve in an injector of a common rail diesel engine can be removed.

### DESCRIPTION OF EMBODIMENTS

The additive composition of the present invention is used by mixing with fuel for a common rail diesel engine. The method for mixing is not particularly limited, and the additive composition of the present invention may be added to and mixed with diesel fuel, or diesel fuel may be added to and mixed with the additive composition of the present invention.

The additive composition of the present invention contains the following component (a) to component (c):
(a) a compound represented by the formula (1),
(b) a compound represented by the formula (2), and
(c) a compound represented by the formula (3) and/or a compound represented by the formula (4).

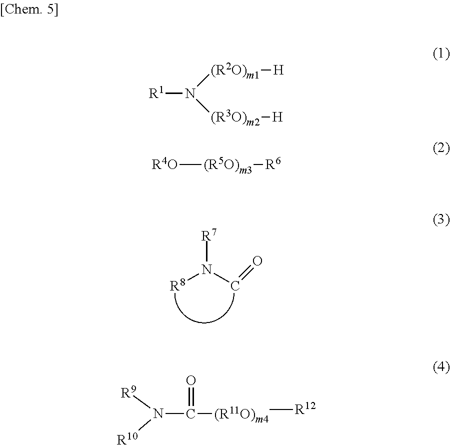

Each component is described below in order. In the present specification, “a compound represented by the formula (1)” is sometimes abbreviated as “compound (1)”. Compounds represented by other formulas are also sometimes abbreviated in the same manner.

R¹ in the formula (1) is an alkenyl group having 12 to 22 carbon atoms.

In the present specification, the alkenyl group may be linear or branched. In addition, the alkenyl group may have plural carbon-carbon double bonds.

In the present specification, examples of the alkenyl group having 12 to 22 carbon atoms include dodecenyl group, tetradecenyl group, hexadecenyl group, octadecenyl group (particularly, oleyl group), icosenyl group, docosenyl group, octadecadienyl group, and the like.

From the viewpoint of permeability of the mixture of the additive composition and diesel fuel into the gaps, R¹ is preferably a linear alkenyl group having 12 to 22 carbon atoms, more preferably a linear alkenyl group having 16 to 22 carbon atoms, further preferably an oleyl group.

R² and R³ in the formula (1) are each independently an alkylene group having 2 to 4 carbon atoms.

In the present specification, the alkylene group may be linear or branched.

In the present specification, examples of the alkylene group having 2 to 4 carbon atoms include ethylene group, trimethylene group (—(CH₂)₃—), branched propylene group (—CH₂CH(CH₃)— or —CH(CH₃)CH₂—), tetramethylene group (—(CH₂)₄—), branched butylene group (—CH₂CH(CH₂CH₃)— or —CH(CH₂CH₃)CH₂—), and the like.

R² and R³ are the same as or different from each other. From the viewpoint of easy availability of compound (1), R² and R³ are preferably both ethylene groups or branched propylene groups (—CH₂CH(CH₃)— or —CH(CH₃)CH₂—), more preferably both ethylene groups.

In the present specification, “R² and R³ are both ethylene groups or branched propylene groups” means that R² and R³ are the same as each other and each is an ethylene group or a branched propylene group. Other expressions similar to the “R² and R³ are both ethylene groups or branched propylene groups” also have the same meaning as “R² and R³ are both ethylene groups or branched propylene groups”.

In the formula (1), m1 and m2 are each independently an integer of 1 to 10. From the viewpoints of dispersion of contaminants and prevention of reattachment, m1 and m2 are preferably each independently an integer of 1 to 3.

When m1 is an integer of two or more, multiple R²s are the same as or different from each other. For example, when R² is an ethylene group or a branched propylene group and m1 is an integer of two or more, (R²O)ₘ₁ in the formula (1) may be any of an ethylene oxide homopolymer chain, a propylene oxide homopolymer chain, and a copolymer chain of ethylene oxide and propylene oxide.

When m2 is an integer of two or more, multiple R³s are the same as or different from each other. For example, when R³ is an ethylene group or a branched propylene group and m2 is an integer of two or more, (R³O)ₘ₂ in the formula (1) may be any of an ethylene oxide homopolymer chain, a propylene oxide homopolymer chain, and a copolymer chain of ethylene oxide and propylene oxide.

Only one kind of compound (1) may be used, or two or more kinds thereof may be used in combination. Compound (1) can be produced by adding alkylene oxide having 2 to 4 carbon atoms to a primary amine having an alkenyl group having 12 to 22 carbon atoms.

Examples of the aforementioned primary amine include dodecenyl amine, tetradecenyl amine, hexadecenyl amine, oleyl amine, icosenyl amine, docosenyl amine, octadecadienyl amine, and the like, and oleyl amine is desirable since it is industrially easily available and shows good thermal stability.

The alkylene oxide having 2 to 4 carbon atoms may be any of ethylene oxide, propylene oxide, and butylene oxide, and ethylene oxide and propylene oxide are preferred due to their cost and good commercial availability.

From the viewpoints of dispersion of contaminants and prevention of reattachment, compound (1) is preferably a compound in which R¹ in the formula (1) is an oleyl group, R² and R³ are both ethylene groups or branched propylene groups, m1 and m2 are each independently an integer of 1 to 3, when m1 is an integer of two or more, multiple R²s are the same as or different from each other, and when m2 is an integer of two or more, multiple R³s are the same as or different from each other.

R⁴ in the formula (2) is an alkyl group having 1 to 8 carbon atoms.

In the present specification, the alkyl group may be linear or branched.

In the present specification, examples of the alkyl group having 1 to 8 carbon atoms include methyl group, ethyl group, propyl group, butyl group, pentyl group, hexyl group, heptyl group, octyl group, and the like.

In the present specification, examples of the alkyl group having 1 to 4 carbon atoms include methyl group, ethyl group, propyl group, butyl group, and the like.

From the viewpoints of removal of contaminants and solubility of the additive composition in fuel, R⁴ is preferably a linear alkyl group having 1 to 8 carbon atoms, more preferably a linear alkyl group having 1 to 4 carbon atoms, further preferably a butyl group.

R⁵ in the formula (2) is an alkylene group having 2 to 4 carbon atoms. R⁵ is preferably an ethylene group or a branched propylene group (—CH₂—CH(CH₃)— or —CH(CH₃)—CH₂—), more preferably an ethylene group, due to the good commercial availability of compound (2), and from the viewpoint of permeability of a mixture of the additive composition and diesel fuel into the gaps.

R⁶ in the formula (2) is a hydrogen atom or an alkyl group having 1 to 8 carbon atoms. R⁶ is preferably a hydrogen atom or an alkyl group having 1 to 4 carbon atoms, more preferably a hydrogen atom or a linear alkyl group having 1 to 4 carbon atoms, further preferably a hydrogen atom or a butyl group, from the viewpoints of removal of contaminants and permeability of a mixture of the additive composition and diesel fuel into the gaps.

In the formula (2), m3 is an integer of 1 to 4. From the viewpoint of permeability of a mixture of the additive composition and diesel fuel into the gaps, m3 is preferably an integer of 1 to 3, more preferably 2 or 3, further preferably 2.

When m3 is an integer of two or more, multiple R⁵s are the same as or different from each other, preferably multiple R⁵s are the same as each other.

Specific examples of compound (2) include ethylene glycol monomethyl ether, ethylene glycol monoethyl ether, ethylene glycol monopropyl ether, ethylene glycol monobutyl ether, diethylene glycol monomethyl ether, diethylene glycol monoethyl ether, diethylene glycol monopropyl ether, diethylene glycol monobutyl ether, triethylene glycol monomethyl ether, triethylene glycol monoethyl ether, triethylene glycol monopropyl ether, triethylene glycol monobutyl ether, propylene glycol monomethyl ether, propylene glycol monoethyl ether, propylene glycol monopropyl ether, propylene glycol monobutyl ether, dipropylene glycol monomethyl ether, dipropylene glycol monoethyl ether, dipropylene glycol monopropyl ether, dipropylene glycol monobutyl ether, tripropylene glycol monomethyl ether, tripropylene glycol monoethyl ether, tripropylene glycol monopropyl ether, tripropylene glycol monobutyl ether, ethylene glycol dimethyl ether, ethylene glycol diethyl ether, ethylene glycol dipropyl ether, ethylene glycol dibutyl ether, ethylene glycol ethyl methyl ether, ethylene glycol propyl methyl ether, ethylene glycol butyl methyl ether, diethylene glycol dimethyl ether, diethylene glycol diethyl ether, diethylene glycol dipropyl ether, diethylene glycol dibutyl ether, diethylene glycol ethyl methyl ether, diethylene glycol propyl methyl ether, diethylene glycol butyl methyl ether, triethylene glycol dimethyl ether, triethylene glycol diethyl ether, triethylene glycol dipropyl ether, triethylene glycol dibutyl ether, triethylene glycol ethyl methyl ether, triethylene glycol propyl methyl ether, triethylene glycol butyl methyl ether, propylene glycol dimethyl ether, propylene glycol diethyl ether, propylene glycol dipropyl ether, propylene glycol dibutyl ether, dipropylene glycol dimethyl ether, dipropylene glycol diethyl ether, dipropylene glycol dipropyl ether, dipropylene glycol dibutyl ether, tripropylene glycol dimethyl ether, tripropylene glycol diethyl ether, tripropylene glycol dipropyl ether, tripropylene glycol dibutyl ether, and the like.

Among the above-mentioned specific examples of compound (2), diethylene glycol monoalkyl ether and diethylene glycol dialkyl ether are preferred from the viewpoints of being industrially produced and easily available, and performance as a cleaning agent, and diethylene glycol monobutyl ether and diethylene glycol dibutyl ether are more preferred since they can be stably added to fuel as additives.

Only one kind of compound (2) may be used, or two or more kinds thereof may be used in combination. Compound (2) may be a commercially available product or may be synthesized by a known method.

R⁷ in the formula (3) is an alkyl group having 1 to 8 carbon atoms. R⁷ is preferably a linear alkyl group having 1 to 8 carbon atoms, more preferably a methyl group, an ethyl group, or an octyl group, further preferably a methyl group, from the viewpoints of swelling of contaminants, and permeability of a mixture of the additive composition and diesel fuel into the gaps.

R⁸ in the formula (3) is an alkylene group having 2 to 5 carbon atoms, and connects the imino group (—N(R⁷)—) and the carbonyl group (—CO—) in the formula (3). From the viewpoint of swelling of contaminants, R⁸ is preferably a linear alkylene group having 3 to 5 carbon atoms, more preferably a trimethylene group (—(CH₂)₃—).

Specific examples of compound (3) include N-methylpyrrolidone, N-ethylpyrrolidone, N-octylpyrrolidone, N-methyl-2-piperidone, N-ethyl-2-piperidone, N-methyl-ε-caprolactam, and the like. Compound (3) may be a commercially available product or may be synthesized by a known method. Only one kind of compound (3) may be used, or two or more kinds thereof may be used in combination. Compound (3) includes preferably N-methylpyrrolidone and/or N-ethylpyrrolidone, more preferably N-methylpyrrolidone.

R⁹ and R¹⁰ in the formula (4) are each independently an alkyl group having 1 to 4 carbon atoms. R⁹ and R¹⁰ are the same as or different from each other, and R⁹ and R¹⁰ are preferably the same as each other. R² and R³ are preferably both alkyl groups having 1 to 4 carbon atoms, more preferably both linear alkyl groups having 1 to 4 carbon atoms, further preferably both methyl groups, from the viewpoint of easy availability of compound (4).

R¹¹ in the formula (4) is an alkylene group having 2 to 4 carbon atoms. R¹¹ is preferably an ethylene group from the viewpoint of easy availability of compound (4).

R¹² in the formula (4) is an alkyl group having 1 to 4 carbon atoms. R¹² is preferably a linear alkyl group having 1 to 4 carbon atoms, more preferably a methyl group or a butyl group, further preferably a butyl group, from the viewpoints of swelling of contaminants, and permeability of a mixture of the additive composition and diesel fuel into the gaps.

In the formula (4), m4 is an integer of 1 to 3, and when m4 is an integer of two or more, multiple R¹¹s are the same as or different from each other. From the viewpoint of easy availability of compound (4), m4 is preferably 1.

Specific examples of compound (4) include 3-methoxy-N,N-dimethylpropanamide, 3-butoxy-N,N-dimethylpropanamide, and the like. Compound (4) may be a commercially available product or may be synthesized by a known method. Only one kind of compound (4) may be used, or two or more kinds thereof may be used in combination, compound (4) is preferably 3-butoxy-N,N-dimethylpropanamide.

As component (c), preferably N-methylpyrrolidone, N-ethylpyrrolidone, and 3-butoxy-N,N-dimethylpropanamide are preferred, and N-methylpyrrolidone and 3-butoxy-N,N-dimethylpropanamide are more preferred, from the viewpoints of being industrially produced and easily available, and performance as a cleaning agent.

Component (c) is composed of compound (3) and/or compound (4), preferably compound (3) or compound (4).

The content of component (a) (i.e., compound (1)) is 2 to 85% by mass, preferably 2 to 80% by mass, based on the whole additive composition. When the content of component (a) is less than 2% by mass, the ability of the additive composition to disperse contaminants is reduced and engine starting at low temperatures is hindered. On the other hand, when the content of component (a) exceeds 85% by mass, the proportion of component (b) or component (c) in the additive composition decreases, which in turn lowers the ability of the additive composition to penetrate gaps, and makes removal of contaminants difficult.

The content of component (b) (i.e., compound (2)) is 10 to 85% by mass, preferably 10 to 40% by mass, based on the whole additive composition. When the content of component (b) is less than 10% by mass, the ability of the additive composition to penetrate gaps becomes low, making removal of contaminants difficult. On the other hand, when the content of component (b) exceeds 85% by mass, the proportion of component (a) decreases, which in turn makes dispersion of contaminants difficult and makes removal of contaminants difficult.

The content of component (c) (i.e., compound (3) and/or compound (4)) is 5 to 50% by mass, preferably 5 to 30% by mass, based on the whole additive composition. When the content of component (c) is less than 5% by mass, the ability of the additive composition to penetrate gaps lowers, the action of swelling contaminants becomes low, and removal of contaminants becomes difficult. On the other hand, when the content of component (c) exceeds 50% by mass, resin parts that come into contact with fuel may swell to cause malfunction. When compound (3) and compound (4) are used in combination as component (c), the content of component (c) means the total content of compound (3) and compound (4).

The total content of component (a) to component (c) is 20 to 100% by mass, preferably 25 to 100% by mass, based on the whole additive composition. When the aforementioned total is less than 20% by mass, the ability of the additive composition to penetrate gaps lowers, which may hinder cleaning of the control valve.

The additive composition of the present invention may also contain other components different from components (a) to (c) within the range not inhibiting the effects of the present invention. Examples of other components include water, alkylene oxide adducts of saturated alkylamine, cetane improvers such as octyl nitrate, cyclohexyl nitrate, and the like, cleaners such as polyetheramine, polybutenylamine, and the like, corrosion inhibitors such as aliphatic amine, alkenyl succinate ester, and the like, and deicing agents such as polyglycol ether and the like.

The additive composition of the present invention is preferably used in fuel for common rail diesel engine with a fuel injection pressure of 200 MPa or more.

The present invention also provides a method for cleaning a control valve inside an injector of a common rail diesel engine, including supplying a mixture of the additive composition of the present invention and diesel fuel (i.e., diesel fuel containing the additive composition of the present invention) to the common rail diesel engine, wherein the content of the aforementioned composition in the aforementioned mixture is 0.5 to 5 parts by mass relative to 100 parts by mass of the diesel fuel. The method for cleaning a control valve inside an injector of a common rail diesel engine means a method for removing contaminants of the aforementioned control valve.

Examples of the embodiment of supplying a mixture of the additive composition of the present invention and diesel fuel to a common rail diesel engine include
(i) adding the additive composition of the present invention to a fuel tank containing diesel fuel and supplying the obtained mixture to an engine, and
(ii) adding the aforementioned mixture prepared in advance into a fuel tank and supplying the mixture to an engine.

In the aforementioned method, when the content of the additive composition of the present invention is less than 0.5 parts by mass relative to 100 parts by mass of diesel fuel, sufficient cleaning performance may not be achieved. On the other hand, when the content of the additive composition of the present invention exceeds 5 parts by mass relative to 100 parts by mass of diesel fuel, adverse effects on resin parts of common rail diesel engine and the like may be developed.

### EXAMPLE

The present invention is explained in more detail in the following by referring to Examples; however, the present invention is not limited by the following Examples.

The “%” and “parts” in the following mean “% by mass” and “parts by mass”, respectively.

### Examples 1 to 3 and Comparative Examples 1 to 16

Additive compositions were produced by mixing the components shown in Table 1 or 2 in the amounts shown in Table 1 or 2. In Comparative Examples 14 to 16, the components shown in Table 2 were used as additives.

N,N-bis(2-hydroxyethyl)oleylamine used in Examples 1 to 3 is a compound in which R¹ is an oleyl group, R² and R³ are both ethylene groups, and m1 and m2 are both 1 in the formula (1).

TABLE 1

| | component (content) |
|---|---|
| Example 1 | N,N-bis(2-hydroxyethyl)oleylamine (70%) + |
| | diethylene glycol monobutyl ether (15%) + |
| | N-methylpyrrolidone (15%) |
| Example 2 | N,N-bis(2-hydroxyethyl)oleylamine (70%) + |
| | diethylene glycol monobutyl ether (15%) + |
| | 3-butoxy-N,N-dimethylpropanamide (15%) |
| Example 3 | N,N-bis(2-hydroxyethyl)oleylamine (70%) + |
| | diethylene glycol monobutyl ether (10%) + |
| | diethylene glycol dibutyl ether (10%) + |
| | N-methylpyrrolidone (10%) |

TABLE 2

| | component (content) |
|---|---|
| Comparative | N,N-bis(2-hydroxyethyl)oleylamine (70%) + |
| Example 1 | diethylene glycol monobutyl ether (30%) |
| Comparative | N,N-bis(2-hydroxyethyl)oleylamine (70%) + |
| Example 2 | diethylene glycol dibutyl ether (30%) |
| Comparative | N,N-bis(2-hydroxyethyl)oleylamine (70%) + |
| Example 3 | N-methylpyrrolidone (30%) |
| Comparative | N,N-bis(2-hydroxyethyl)oleylamine (70%) + |
| Example 4 | 3-butoxy-N,N-dimethylpropanamide (30%) |
| Comparative | N,N-bis(2-hydroxyethyl)laurylamine (70%) + |
| Example 5 | diethylene glycol monobutyl ether (15%) + |
| | N-methylpyrrolidone (15%) |
| Comparative | N,N-bis(2-hydroxyethyl)laurylamine (70%) + |
| Example 6 | diethylene glycol monobutyl ether (15%) + |
| | 3-butoxy-N,N-dimethylpropanamide (15%) |
| Comparative | N,N-bis(2-hydroxyethyl)laurylamine (70%) + |
| Example 7 | diethylene glycol monobutyl ether (30%) |
| Comparative | N,N-bis(2-hydroxyethyl)laurylamine (70%) + |
| Example 8 | diethylene glycol dibutyl ether (30%) |
| Comparative | N,N-bis(2-hydroxyethyl)laurylamine (70%) + |
| Example 9 | N-methylpyrrolidone (30%) |
| Comparative | N,N-bis(2-hydroxyethyl)laurylamine (70%) + |
| Example 10 | 3-butoxy-N,N-dimethylpropanamide (30%) |
| Comparative | N,N-bis(2-hydroxyethyl)oleylamine (70%) + |
| Example 11 | hydrocarbon solvent (30%) |
| Comparative | N,N-bis(2-hydroxyethyl)laurylamine (70%) + |
| Example 12 | hydrocarbon solvent (30%) |
| Comparative | N,N-bis(2-hydroxyethyl)laurylamine (70%) + |
| Example 13 | diethylene glycol monobutyl ether (15%) + |
| | diethylene glycol dibutyl ether (10%) + |
| | N-methylpyrrolidone (5%) |
| Comparative | diethylene glycol monobutyl ether (100%) |
| Example 14 | |
| Comparative | diethylene glycol dibutyl ether (100%) |
| Example 15 | |
| Comparative | 3-butoxy-N,N-dimethylpropanamide (100%) |
| Example 16 | |

### <Permeability Test>

The additive composition or additive of Examples 1 to 3 or Comparative Examples 1 to 16 was dissolved in a hydrocarbon solvent to prepare a solution (additive composition content: 10 parts per 100 parts of hydrocarbon hydrogen solvent). The obtained solution was contacted with a capillary tube (inner diameter: 0.25 mm) at room temperature (25° C.), and the time required for the liquid level to reach 10 mm or 40 mm (hereinafter referred to as the “10 mm arrival time” or “40 mm arrival time”) was measured. The solution was also contacted with a capillary tube (inner diameter: 0.25 mm) at room temperature (25° C.) and left for a predetermined period of time, and then the height reached by liquid level (maximum height) in the capillary tube was determined. Similarly, as Reference Example 1, 10 mm arrival time, 40 mm arrival time, and the height reached were measured using a hydrocarbon solvent without the additive composition. The 10 mm arrival time, 40 mm arrival time, and the height reached were evaluated according to the following criteria, and the average of these three (hereinafter referred to as the “average evaluation”) was calculated. The results and evaluation are shown in Table 3.

### (Evaluation Criteria of 10 mm Arrival Time)

3: less than 0.5 sec
2: 0.5 sec or more and less than 0.7 sec
1: 0.7 sec or more and less than 0.9 sec
0: 0.9 sec or more

### (Evaluation Criteria of 40 mm Arrival Time)

3: less than 16 sec
2: 16 sec or more and less than 18 sec
1: 18 sec or more and less than 20 sec
0: 20 sec or more

### (Evaluation Criteria of Height Reached)

3: 44.0 mm or more
2: 43.5 mm or more and less than 44.0 mm
1: 43.0 mm or more and less than 43.5 mm
0: less than 43.0 mm

### <Cleaning Test>

A contaminated control valve was removed from the injector of a common-rail diesel engine (fuel injection pressure: 200 MPa or higher) and immersed for 24 hours in a light oil mixture containing the additive composition or additive of Examples 1 to 3 or Comparative Examples 1 to 16 and light oil (additive composition content: 1% of the whole mixture). Then, the degree of removal of the attached substance was confirmed by visual observation and evaluated according to the following criteria. As Reference Example 1, a similar test was conducted using light oil not containing the additive composition, and the degree of removal of the attached substance was confirmed by visual observation and evaluated according to the following criteria. The evaluation is shown in Table 3.

### (Evaluation Criteria)

3: attached substance was almost completely removed
2: attached substance was mostly removed
1: only a small amount of attached substance was removed
0: attached substance was hardly removed

### <Overall Evaluation of Additive Composition or Additive>

The overall evaluation of the additive composition or additive was performed using the total of the average evaluation of the permeability test and the evaluation of the cleaning test, and according to the following criteria. The overall evaluation is shown in Table 3.

### (Criteria of Overall Evaluation)

⊙: the aforementioned total of 5.0 or more
O: the aforementioned total of 4.0 or more and less than 5.0
Δ: the aforementioned total of 3.0 or more and less than 4.0
x: the aforementioned total of less than 3.0

TABLE 3

| | permeability test | | | | | | | cleaning | |
|---|---|---|---|---|---|---|---|---|---|
| | 10 mm arrival time | | 40 mm arrival time | | height reached | | average | test | overall |
| | results | evalua- | results | evalua- | results | evalua- | evalua- | evalua- | evalua- |
| | (sec) | tion | (sec) | tion | (mm) | tion | tion | tion | tion |
| Ex. 1 | 0.2 | 3 | 16.9 | 2 | 44.0 | 3 | 2.7 | 3 | ⊙ |
| Ex. 2 | 0.4 | 3 | 15.2 | 3 | 44.0 | 3 | 3.0 | 3 | ⊙ |
| Ex. 3 | 0.4 | 3 | 16.8 | 3 | 44.7 | 3 | 3.0 | 3 | ⊙ |
| Comp. Ex. 1 | 0.9 | 0 | 16.7 | 2 | 44.0 | 3 | 1.7 | 0 | X |
| Comp. Ex. 2 | 0.8 | 1 | 16.3 | 2 | 44.0 | 3 | 2.0 | 0 | X |
| Comp. Ex. 3 | 1.0 | 0 | 23.9 | 0 | 43.8 | 2 | 0.7 | 1 | X |
| Comp. Ex. 4 | 0.4 | 3 | 20.6 | 0 | 43.0 | 1 | 1.3 | 1 | X |
| Comp. Ex. 5 | 0.6 | 2 | 27.6 | 0 | 43.0 | 1 | 1.0 | 3 | ◯ |
| Comp. Ex. 6 | 1.5 | 0 | 20.9 | 0 | 42.0 | 0 | 0.0 | 3 | Δ |
| Comp. Ex. 7 | 0.8 | 1 | 21.8 | 0 | 42.3 | 0 | 0.3 | 0 | X |
| Comp. Ex. 8 | 0.7 | 1 | 17.2 | 2 | 43.0 | 1 | 1.3 | 0 | X |
| Comp. Ex. 9 | 0.7 | 1 | 19.2 | 1 | 43.0 | 1 | 1.0 | 2 | Δ |
| Comp. Ex. 10 | 0.8 | 1 | 18.2 | 1 | 42.3 | 0 | 0.7 | 2 | X |
| Comp. Ex. 11 | 0.7 | 1 | 19.2 | 1 | 43.0 | 1 | 1.0 | 0 | X |
| Comp. Ex. 12 | 1.0 | 0 | 18.2 | 1 | 42.0 | 0 | 0.3 | 0 | X |
| Comp. Ex. 13 | 0.7 | 1 | 19.2 | 1 | 43.8 | 2 | 1.3 | 3 | ◯ |
| Comp. Ex. 14 | 0.6 | 2 | 17.6 | 2 | 44.0 | 3 | 2.3 | 0 | X |
| Comp. Ex. 15 | 0.6 | 2 | 15.7 | 3 | 44.0 | 3 | 2.7 | 0 | X |
| Comp. Ex. 16 | 0.6 | 2 | 15.9 | 3 | 44.0 | 3 | 2.7 | 0 | X |
| Ref. Ex. 1 | 0.6 | 2 | 16.2 | 2 | 44.0 | 3 | 2.3 | 0 | X |

As shown in Table 3, it is clear that the additive composition of the present invention easily penetrates narrow gaps, and shows good cleaning performance on common rail diesel engine parts (particularly, control valve inside an injector).

### INDUSTRIAL APPLICABILITY

The additive composition of the present invention is useful for cleaning common rail diesel engine (particularly, control valve inside the injector thereof).

This application is based on a patent application No. 2023-064216 filed in Japan, the contents of which are encompassed in full herein.

1. An additive composition for fuel for a common rail diesel engine, comprising the following component (a) to component (c):
(a) a compound represented by the formula (1): 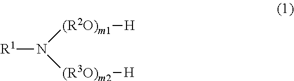
wherein
R¹ is an alkenyl group having 12 to 22 carbon atoms,
R² and R³ are each independently an alkylene group having 2 to 4 carbon atoms,
m1 and m2 are each independently an integer of 1 to 10,
when m1 is an integer of two or more, multiple R²s are the same as or different from each other, and
when m2 is an integer of two or more, multiple R³s are the same as or different from each other,
(b) a compound represented by the formula (2): 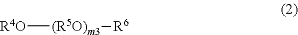
wherein
R⁴ is an alkyl group having 1 to 8 carbon atoms,
R⁵ is an alkylene group having 2 to 4 carbon atoms,
R⁶ is a hydrogen atom or an alkyl group having 1 to 8 carbon atoms,
m3 is an integer of 1 to 4, and
when m3 is an integer of two or more, multiple R³s are the same as or different from each other, and
(c) a compound represented by the formula (3): 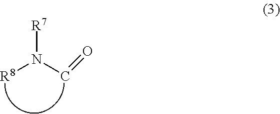
wherein
R⁷ is an alkyl group having 1 to 8 carbon atoms, and
R⁸ is an alkylene group having 2 to 5 carbon atoms, and/or
a compound represented by the formula (4): 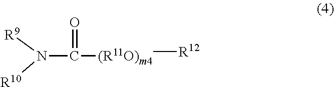
wherein
R⁹ and R¹⁰ are each independently an alkyl group having 1 to 4 carbon atoms,
R¹¹ is an alkylene group having 2 to 4 carbon atoms,
R¹² is an alkyl group having 1 to 4 carbon atoms,
m4 is an integer of 1 to 3, and
when m4 is an integer of two or more, multiple R¹¹s are the same as or different from each other,
wherein a content of component (a) is 2 to 85% by mass, a content of component (b) is 10 to 85% by mass, a content of component (c) is 5 to 50% by mass, and a total content of component (a) to component (c) is 20 to 100% by mass, each based on the whole additive composition.

2. The additive composition according to claim 1, which is for a fuel for a common rail diesel engine with a fuel injection pressure of 200 MPa or more.

3. A method for cleaning a control valve inside an injector of a common rail diesel engine, comprising supplying a mixture of the additive composition according to claim 1 and diesel fuel to the common rail diesel engine, wherein a content of the composition in the mixture is 0.5 to 5 parts by mass relative to 100 parts by mass of the diesel fuel.
